(19) United States
(12) Patent Application Publication
(10) Pub. No.: US 2026/0203049 A1
(43) Pub. Date: Jul. 16, 2026

(54) Automated Computer Application Modification and Customization

(71) Applicant: Bank of America Corporation, Charlotte, NC (US)

(72) Inventors: Saurabh Arora, Haryana (IN); Sandeep Kumar Chauhan, Telangana (IN); Srikanth Vishwappa, Hyderabad (IN)

(21) Appl. No.: 19/016,346

(22) Filed: Jan. 10, 2025

(51) Int. Cl. G06F 8/70; G06F 8/36; G06F 11/34; G06F 40/205

(52) U.S. Cl. CPC G06F 8/70; G06F 8/36; G06F 11/3438; G06F 40/205

(57) ABSTRACT

Computer application features are often static until a global change is made in the application for all users. That is, application features are often not dynamically changed or updated as user needs arise. Systems and methods provide for a system and method for determining requested application features, prioritizing feature additions, and generating a modified application with the feature additions. In some examples, application feature needs or requests may be determined from explicit user requests or inferred from user actions. Further, feature additions may be prioritized based on whether code for the features to be added already exist. An application may then be customized based on the prioritized feature additions. In one or more arrangements, pre-existing feature code may be used in customizing the application.

### BACKGROUND

Aspects described herein relate to electrical computers, networks, systems, and devices for creating and modifying applications with customized application code and features.

Computer applications are used in many facets of life, including for communication and performance of automated functions. These applications are used at home, in businesses, and within communities. A business or organization, for instance, may create, host, and use hundreds or thousands of applications. Those applications, in turn, may be used by hundreds, thousands or even millions of internal and/or external users. In some cases, different users may have different requirements, desires or preferences for a particular application. However, with current application systems, the application features are often standardized, and there is no efficient way in which the application features may be customized based on user feedback such as feature requests, preference indications, and the like.

Additionally, although applications are often built using separable code segments or packages corresponding to various functions or features, these code segments or packages are often only associated with a single application despite possible advantages to implementing those code segments or packages (and thus, the corresponding features) in other applications or programs.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

By addressing one or more of the above noted challenges, computer applications (e.g., desktop applications, web applications, mobile applications) may be better customized and customized more efficiently based on user feedback and requests.

Accordingly, aspects described herein relate to systems, methods, apparatuses and processes for modifying features or functions available through a computer application. For example, an application customization system and method may receive feedback such as requests from users of an application. This feedback may include requests for particular features or functions for that application. The system and method may collect the feedback and prioritize certain features or functions for addition to the application. The method and system may further identify user interface elements as well as other functional elements that are necessary for adding the requested feature or function to the application. Once identified, computer code associated with those identified elements may be merged into a new customized application package in which the requested features are available.

According to one or more aspects, the feedback collected through an original application may further include tracking user interactions with the application. For example, the system and method may determine an amount of time spent on an application input field, an application screen, a communication session facilitated through the application and the like. In other examples, feedback may include whether a user requested help (e.g., a help chat session, activating a help link or other help information available through the application). These types of feedback may be used to infer user preferences or needs for a particular application in order to identify possible functions or features that would be helpful or desirable to add.

According to one or more further aspects, the system and method may use a variety of factors and considerations when prioritizing feature or function requests (i.e., application customization requests). In one example, the system and method may determine whether code for the requested features or functions already exists within the system. If so, the requests associated with those features or functions may be prioritized ahead of other requests that may require code creation.

Further, according to some aspects, if new code is required for a requested function or feature, the system and method may further determine preferences associated with a requesting user. These preferences may include code scheme, information or input field placements, preferred types of input fields (e.g., radio buttons vs. drop down menu) and the like. The system and method may generate a new user interface using these determined preferences as part of the new code for implementing the requested function or feature within the original application. In some arrangements, generating new code may include retrieving existing code modules or segments (e.g., for a particular type of input field, for a particular type of calculation, communication protocols or elements) in order to construct the overall feature, function and/or user interface associated therewith.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for an application customization and modification system in accordance with one or more aspects described herein;

FIG. 2 is a system diagram illustrating a process flow for analyzing application feedback and processing application customization and modifications according to one or more aspects described herein;

FIG. 3 is a flowchart illustrating an example process for application modification and customization according to one or more aspects described herein;

FIG. 4 is a flowchart illustrating an example process for modifying an application user interface for newly added functionality according to one or more aspects described herein; and

FIG. 5 depicts an illustrative architecture and operating environment for an application customization and modification system according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, a computer application may be used by many users, and some users may wish to modify the features or functions available through the application. In one example, a live chat application may include font size and style functions, but not a feature for inputting emojis or images. Accordingly, users may request that such a feature (e.g., to be able to input and communicate images and/or emojis) be added to the live chat application. In another example, users may wish to add a calculator function to a retirement planning web application. In still another example, users may provide feedback requesting an amortization schedule feature (e.g., calculator) be added to a mortgage mobile application.

Accordingly, systems and methods provided herein may collect the requests and feedback and generate new versions or builds of the application with the requested features. In some examples, the requests may be prioritized or otherwise organized or sorted based on whether the system has existing code corresponding to those features. If existing code is stored in or otherwise available to the system, application customization or modification may be completed in less time and with less effort than if code does not currently exist.

In some arrangements, new versions of an application may be generated by assembling existing code modules or segments corresponding to portions of the requested features or functions, even if a complete code module does not exist for the entirety of the requested feature. For example, a request for a feature to input emojis in a live chat may correspond to a code segment for attaching images to an input field and a separate code segment for transmitting images through the network. Additionally, in some instances where a new function or feature is added, new user interface elements may need to be defined and created to provide the requested feature or function through the original application. Accordingly, the system and method may generate those interface elements as well.

By allowing for application customization or modification, users may find use of an application to be more efficient, helpful, and/or enjoyable. The application customization and modification systems and methods described may provide a more efficient and faster mechanism than requiring complete re-designing or re-coding of an application to implement the desired features or functions.

These and various other arrangements will be discussed more fully below.

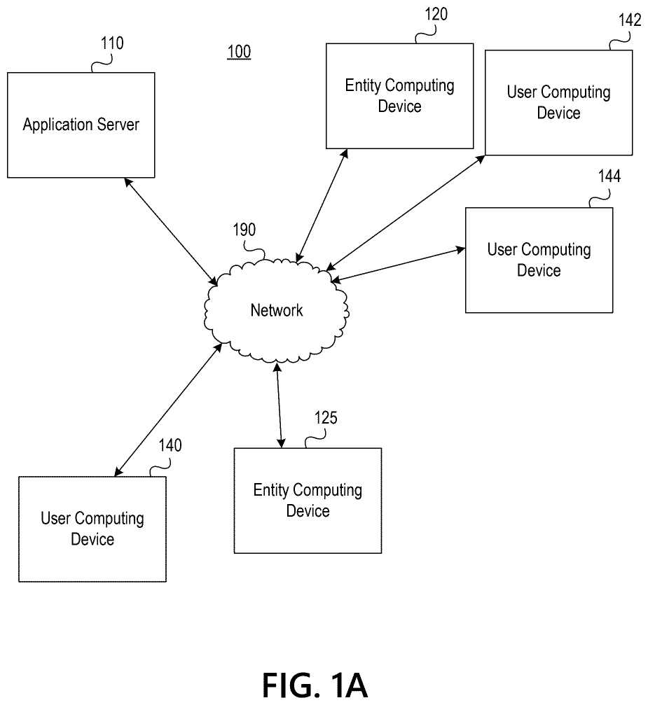

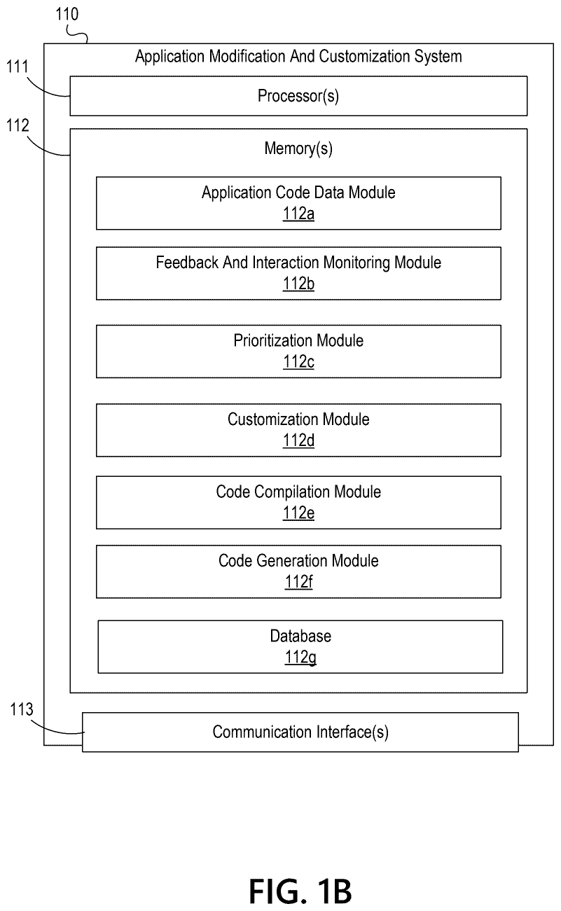

FIGS. 1A-1B depict an illustrative computing environment for implementing a computer application customization and modification system and process in accordance with one or more aspects described herein. Referring to FIG. 1A, computing environment 100 may include one or more computing devices and/or other computing systems. For example, computing environment 100 may include an application server or system 110, entity computing systems 120, 125, and user computing devices 140, 142, and 144. Although one application server 110, two entity computing systems 120, 125 and three user computing devices 140, 142, 144 are shown, any number of systems or devices may be used without departing from the invention.

Application system or server 110 may include one or more computing devices (e.g., servers, personal computers (PCs), routers, mobile devices, server blades, or the like) and/or one or more computing components (e.g., memory, processor, and the like) and may be configured to perform a variety of functions and have a variety of capabilities for an organization, entity, or system. For example, the application system or server 110 may correspond to a web server configured to host one or more multimedia processing applications (e.g., image editing, video processing, audio editing). In another example, the application system or server 110 may correspond to a financial transaction system configured to provide financial transaction functions such as applications for payments, loans, withdrawals, deposits, and the like, and auditing and reporting functions. In still another example, application system or server 110 may correspond to an electronic security system configured to store, manage, and provide applications for configuring, monitoring and/or controlling a home or office security system. In each of these arrangements, server 110 may be configured to communicate with and serve applications to a plurality of devices including user computing devices 140, 142, and 144 as well as entity computing systems 120 and 125.

Application system or server 110 may further be configured to detect, receive, or otherwise obtain information about user interactions with the applications that it hosts. For example, the application system or server 110 may monitor user interactions with applications. In one or more arrangements, application system or server 110 may further allow users to download its applications onto their local device (e.g., entity computing system 120 or user computing device 140). In other examples, users may access and execute applications through application system or server 110 (e.g., application system or server 110 runs the applications while providing the output to the user devices). In some cases, the application system or server 110 may determine that a user would like one or more features added to an application. This determination may be made through an explicit user request or through inferring such desires or needs through a user's interactions with an application. For example, the system or server 110 may determine that the user is taking a long time to commit to a loan when being presented with a loan interest rate and loan term. Based on this monitoring, the system or server 110 may determine that the application would benefit from having an amortization calculator in order to help the user decide whether to commit to the loan. In other examples, the system or server 110 may detect that the user accesses a separate application such as a live chat application when accessing the computerized loan application. Accordingly, the system or server 110 may infer that a live chat application may be useful to or desired by the user when using the loan computer application.

Additionally or alternatively, application system or server 110 may use such feedback, inferences, or other information to determine and prioritize features or functions to add to an application. The application system or server 110 may further determine whether code for those functions or features already exists within the system or server 110's ecosystem. If so, the application system or server 110 may prioritize those customizations (e.g., adding those functions or features with existing code) over customizations that may require generating new code.

Application system or server 110 may retrieve or create code for the functions or features that are to be added to one or more applications. In one or more examples, the application system or server 110 may be configured with a database that identifies code modules or segments corresponding to particular features or functions. Accordingly, the system or server 110 may identify the corresponding code that matches or otherwise corresponds with the requested function or feature and retrieve that code from an indicated location. In other examples, the application system or server 110 may determine that code does not already exist for the specified function or feature. In a particular example, the code database or information table might not have an entry for the specified function or feature, which may lead the system or server 110 to determine that pre-defined code has not been created or otherwise does not exist in the application system or server's ecosystem. In such cases, new code may need to be generated and developed.

Once code corresponding to the function or feature has been retrieved or created, the application system or server 110 may be configured to implement the code within an original application's code and interface. In one or more examples, the application system or server 110 may further generate user interface elements as part of generating code for the function or feature to adapt the function or feature to the original application. Additionally or alternatively, the user interface elements may be implemented and coded using a theme or preferences associated with a requesting user or entity. The customized application may then be deployed in a live-use environment in which a requesting user (and other users) may access the application with the newly added features or functions.

Entity computing system 120 and/or entity computing system 125 may be or include one or more computing devices (e.g., servers, routers, gateways, network nodes, personal computers (PCs), mobile devices, server blades, or the like) and/or one or more computing components (e.g., memory, processor, and the like) and may be configured to host or execute one or more organization applications or systems. For instance, entity computing system 120 and/or entity computing system 125 may host or execute internal or user-facing applications or systems that may be accessed by one or more users in-person or remotely, such as via a network, such as a private network, public network, or the like. In one example, entity computing system 120 and 125 may include computers operated by employees of an organization. Those systems 120 and 125 may download or otherwise access applications provided by application server 110. According to one or more arrangements, entity computing system 120 and 125 may be terminals configured to be operated by a customer for providing products or services, general purpose computing devices providing function-specific applications, and/or function-specific devices such as ATMs, maintenance devices, electronic vaults, cash registers, points of sale system, and the like and/or combinations thereof. The entity computing system 120 and/or 125 may further be used to provide information and feedback about applications used by internal and external users.

In one or more examples, entity computing systems 120 and 125 may further include processing systems configured to generate application code such as code for application functions or features. Systems 120 and 125 may further compile application code to generate updated or modified applications. Additionally or alternatively, entity computing systems 120 and 125 may be configured to store code segments or modules for various application functions or features.

User computing device 140 (as well as one or more of user computing devices 142 and 144) may be or include a computing device such as a desktop computer, laptop computer, tablet, smartphone, wearable device, and the like, that is associated with an internal or external user (e.g., internal or external to an organization corresponding to the application server 110). User computing device 140 may communicate with application server 110 and/or entity computing systems 120, 125 to access various application and perform computing activities and transactions. In some arrangements, the user computing device 140 may be a mobile device executing an application used to configure a security monitoring system or to perform financial transactions. In other examples, the user computing device 140 may be an employee computer or computing device used to confirm or approve transactions, communications, and the like. For example, if a request is made to transact a large amount of money, the approval or confirmation may be entered through an application executing on user computing device 140. In still other examples, user computing device 140 may be a user device executing a web browser through which web applications may be accessed and used. Such web applications may include a local area network configuration tool, security monitoring tools, banking web application, web-based chat applications and the like and/or combinations thereof. User computing devices 142 and 144 may be similarly configured.

As mentioned above, computing environment 100 also may include one or more networks, which may interconnect one or more of application system or server 110, entity computing system 120, entity computing system 125, user computing device 140, user computing device 142, and/or user computing device 144. For example, computing environment 100 may include network 190. Network 190 may include one or more sub-networks (e.g., Local Area Networks (LANs), Wide Area Networks (WANs), or the like). Network 190 may be associated with a particular organization (e.g., a corporation, financial institution, educational institution, governmental institution, or the like) and may be a private network interconnecting one or more computing devices associated with the organization. For example, application server 110, entity computing system 120, entity computing system 125, user computing device 140, user computing device 142, and/or user computing device 144 may be associated with an organization (e.g., a financial institution), and network 190 may be associated with and/or operated by the organization, and may include one or more networks (e.g., LANs, WANs, virtual private networks (VPNs), or the like) that interconnect application system or server 110, entity computing system 120, entity computing system 125, user computing device 140, user computing device 142, and/or user computing device 144 and one or more other computing devices and/or computer systems that are used by, operated by, and/or otherwise associated with the organization. Additionally or alternatively, network 190 may be a public network, such as the internet, that may connect the systems and devices described. In yet other examples, network 190 may include a combination of public and private networks.

Referring to FIG. 1B, an application modification and customization system such as application server 110 may include one or more processors 111, memory 112, and communication interface 113. A data bus may interconnect processor(s) 111, memory 112, and communication interface 113. Communication interface 113 may be a network interface configured to support communication between application server 110 and one or more networks (e.g., network 190, or the like). Memory 112 may include one or more program modules having instructions that when executed by processor(s) 111 cause application server 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of application modification and customization system (e.g., server 110) and/or by different computing devices that may form and/or otherwise make up application modification and customization system 110.

For example, memory 112 may have, store and/or include an application code data module 112a. Application code data module 112a may be configured to store information about code modules and segments corresponding to applications available through the application server 110. In some arrangements, the application code data module 112a may store a database such as a table in which different functions or features are identified and associated with location information for the corresponding code segment or module. Those code segments or modules may be used to provide (e.g., execute, perform) the corresponding function or feature. Functions or features may be identified by a name, an alphanumeric code, a number, a filename, and the like and/or combinations thereof. In some cases, the code segment or module location may be indicated by an uniform resource location (URL) or other form of address. Additionally or alternatively, as new code or an application (as a whole) or for certain functions or features, identification of that code and the corresponding application or function may be added to the application code data module 112a. In some arrangements, the application or function code may also be stored in module 112a.

Memory 112 may further have, store and/or include a feedback and interaction monitoring module 112b. Monitoring module 112b may be configured to monitor for user feedback and interactions with applications being executed by users. Based on this feedback and the monitored interactions, the monitoring module 112b may further determine possible features and functions that may be beneficial to add to a particular application. For example, if the monitoring module 112b detects that users frequently access a help function upon reaching a certain input field or application screen, the monitoring module 112b may infer from that interaction that a particular feature or function is to be added to the application to assist with that input field or application screen. In another example, the monitoring module 112b may receive or otherwise detect specific requests for functions or features. A user may, for instance, enter into a comment field or request field information identifying a feature or function that they would like to have added to the application. The monitoring module 112b may be configured to collect and process this feedback to identify requested features or functions for each application.

Monitoring module 112b may be configured to process the feedback and determine requested functions or features on a periodic or aperiodic basis or based on another trigger condition or event. For example, monitoring module 112b may collect and process feedback daily, weekly, monthly, bi-monthly or the like. In other examples, monitoring module 112b may process feedback upon a user initiating a review of the collected information. In still other examples, monitoring module 112b may process feedback during system maintenance periods. That is, when application server 110 enters a maintenance period, that transition into the maintenance period may automatically trigger processing of the feedback by monitoring module 112b.

Memory 112 may further have, store and/or include a prioritization module 112c. Once system 110 has identified or otherwise determined one or more functions or features to be added to one or more applications, prioritization module 112c may then prioritize the addition of those functions or features. Prioritization may be performed using a variety of considerations and factors including a frequency or number of requests for the function or feature, a type of function or feature or application, popularity (e.g., how frequently the application is used) or importance of an application to which the function or feature is to be added, an amount of code needed to implement the new function or feature, and the like and/or combinations thereof. In one arrangement, priority may be determined based on whether code already exists for the requested function or feature. That is, if a requested feature or function has pre-existing code (e.g., specified in the application code data storage 112a), then those requests may be prioritized over requests for functions or features for which pre-existing code is not available or defined (e.g., not specified in the application code data storage 112a). Additionally or alternatively, the requests for features or functions for which pre-existing code is defined may further be prioritized based on one or more factors, including those described above (e.g., frequency of the request, importance of the application, amount of code necessary for implementation).

Memory 112 may further have, store and/or include a customization module 112d configured to manage the implementation of new functions and features into one or more existing applications. Customization module 112d may receive input from prioritization module 112c identifying a priority of functions or features to be added or otherwise implemented in one or more applications. Customization module 112d may then select one of the functions or features to be added to an existing application. For example, customization module 112d may select the top prioritized function or feature. From there, customization module 112d may determine whether code exists for the function or feature. For example, whether code exists for a function or feature may be specified by the prioritization performed by prioritization module 112c and/or customization module 112d may consult the application code data storage 112a to make this determination.

If pre-existing code is available, customization module 112d may retrieve the corresponding code. Customization module 112d may then invoke a code compilation function provided by code compilation module 112e. If pre-existing code is not available, customization module 112d may invoke a code generation function provided through a code generation module 112f, for example. In some arrangements, customization module 112d may manage the implementation of multiple functions or features for multiple applications at the same time. Additionally or alternatively, customization module 112d may manage the sequential implementation of functions and features corresponding to different requests or applications.

Further, customization module 112d may be configured to organize implementation of new features and functions based on application. That is, if multiple functions or features are to be implemented into the same application, the customization module 112d may manage the implementation of all of those functions or features at the same time since they relate to the same application. This is in contrast to implementing each of the functions or features in piecemeal, which the customization module 112d may also be configured to do.

Customization module 112d may further be configured to define or formulate a workflow or process flow for the modified application including the additional function or feature. For example, customization module 112d may determine a time or location at which the function or feature is to be provided within the application. In a particular example, if an application has multiple interface screens, the customization module 112d may identify the screen on which the new function or feature should be presented or displayed. Additionally or alternatively, the customization module 112d may determine a location within the interface where the function or feature is to be implemented. For example, if a calculator function of feature is to be added to a mortgage servicing application, the customization module 112d may determine that the calculator feature should be added adjacent to an interest rate selection field. In another example, in a banking application that allows for funds transfers, an original application may have a first user interface for specifying a source account followed by a second user interface for specifying a destination account. The customization module 112d may determine that a new feature for user authentication prior to allowing selection of a source account is to be implemented as part of the source account selection process.

Application modification and customization system 110 may further have, store and/or include code compilation module 112e. Code compilation module 112e may be used to assemble code segments and modules together and into an existing application. Code compilation module 112e may be configured to retrieve the pre-existing code modules or code segments associated with the functions or features to be added to an existing application. As discussed, the code modules or segments may be identified through the information stored in the application code data storage 112a, and retrieved using the location information provided therein. In one or more arrangements, the code compilation module 112e may program a programming environment in which the retrieve code segments or modules, as well as the application code, is provided. Through this environment, a user may update the application code to incorporate (e.g., invoke) the code segments for the to-be-added feature or function. In other examples, the code compilation module 112e may be configured to simply merge the code segments or modules for the function or feature into the application code. For example, compilation module 112e may insert function calls for invoking the code segments or modules within the original application code. In one example, an insertion mode may be defined based on the determined workflow or process flow. Various other methods of merging code may be used.

Application modification and customization system 110 may further have, store and/or include code generation module 112f. Code generation module 112f may be configured to facilitate code creation for features and functions that do not have existing code available. In one example, code generation module 112f may provide a programming interface through which one or more users may generate the required code for a requested function or feature. In some examples, code generation module 112f may also retrieve pre-existing code for a similar function or feature that may be modified to create the requested function or feature. In one example, a merchant application may require tax calculation using a particular methodology or formula. The customization module 112d may determine that a tax calculator function that calculates a sales tax using a different formula or methodology already exists. In such an instance, the code generating module 112f may retrieve or otherwise obtain the pre-existing tax calculator function code and allow a user to modify that code to create code for the requested tax calculation function.

Application modification and customization system 110 may further have, store and/or include database 112g. Database 112g may store further data, beyond what is stored in or by application code data module 112a. For example, database 112g may store and/or other data that enables performance of aspects described herein by the application modification and customization system 120.

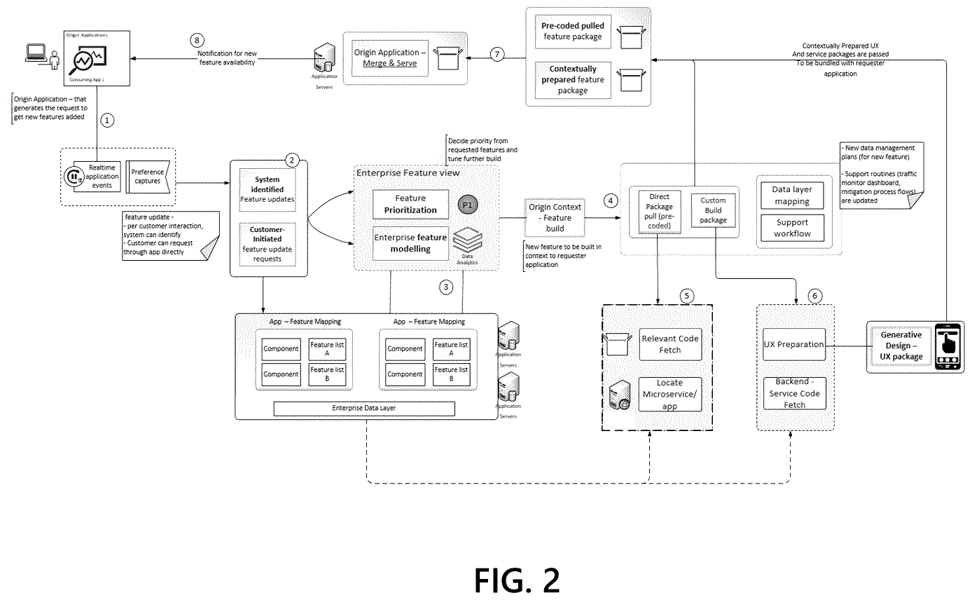

FIG. 2 is a schematic diagram illustrating an example process flow by which an application may be modified to include a new function or feature. For example, flow 200 may begin with an original application being used by a user at step 1. During the use of the original application, various information such as user interactions, user comments, user requests, user preferences and the like may be captured. That information may then be used in step 2 to identify feature or function updates that would be beneficial to the original application. In some examples, the feature or function may be identified by the system processing the user interactions or user preferences. In other examples, the feature or function may be identified by explicit user requests specified through the application or otherwise.

Upon the system identifying new functions or features to be added to one or more original applications, the system may then prioritize feature updates based on various factors as described herein in step 3. In one or more examples, the prioritization may be performed based on whether existing code segments or modules exist for the desired functionality or feature. As shown in FIG. 2, one or more databases (e.g., application code data storage 112a of FIG. 1B) may store a mapping of code modules or segments along with features that the code modules or segments provide. For example, a predefined or pre-existing code module may provide multiple features such as user authentication, password updating, and new user registration. In another example, a single pre-existing code module may provide electronic fund transfer as well as bill payment. In still another example, a single pre-existing code module may provide features including data encryption, data decryption, and data masking. Accordingly, the system may consult the database to determine whether pre-existing code is available for the desired feature or function as one way of prioritizing feature additions. In some instances, the system may also identify feature updates using the database of existing feature elements. For example, the system may make a list of possible features available to a user through the app for the user to select as a requested feature.

In step 3, the system may also perform feature modeling which may include identifying which features and code modules are needed to implement the requested function in the original application. This modelling may be performed using the database feature mapping which may identify the particular code segments or modules necessary to implement the requested function. In one example, if a to-be-added function requires features x, y, and z, enterprise modelling may determine that code segments may be extracted for feature x and z, but not for feature y based on the mapping provided in the database.

Once the prioritization is completed, and relevant code segments or modules have been identified from the database, the system may then determine, in step 4, whether pre-existing code can be retrieved for the desired function or whether new code needs to be generated. If pre-existing code is available to implement the entirety of the desired function or feature, the pre-existing code is obtained, including retrieving or otherwise obtaining any dependencies (e.g., code, microservices and/or apps that are invoked by the corresponding function code) (e.g., step 5). If, on the other hand, pre-existing code does not exist for the desired function (or for the entirety of the function), the system may generate custom code for the feature or function addition as part of step 6. In some examples, code may exist for parts of the desired function. Accordingly, some code may still be obtained for parts of the function, while other parts of the function may require custom code. Pre-existing code may also be adapted in one or more arrangements to modify data layer mappings and/or a support workflow of the feature or function. For example, the pre-existing code may include data layer mappings that is configured to retrieve data from a first database. When implemented in a new application, that data layer mapping may be updated to use data from a second database different from the first database. Support workflows may refer to process support functions including traffic monitoring and mitigation processes. These may need to be adapted as well for the to-be-updated application.

In one or more arrangements, if the function does not have a pre-existing user interface, a user interface may be built in step 6. Additionally or alternatively, the creation of the user interface and implementation of the function may also be customized based on user preferences, a theme (e.g., color, font) of the original application and the like and/or combinations thereof.

The pre-coded function or custom-built function code may then be returned and merged into the original application in step 7. Once merged and implemented into the original application (resulting in a customized or updated application), a notification may be provided in process 8 to a user or organization indicating that a new feature has been added to the application.

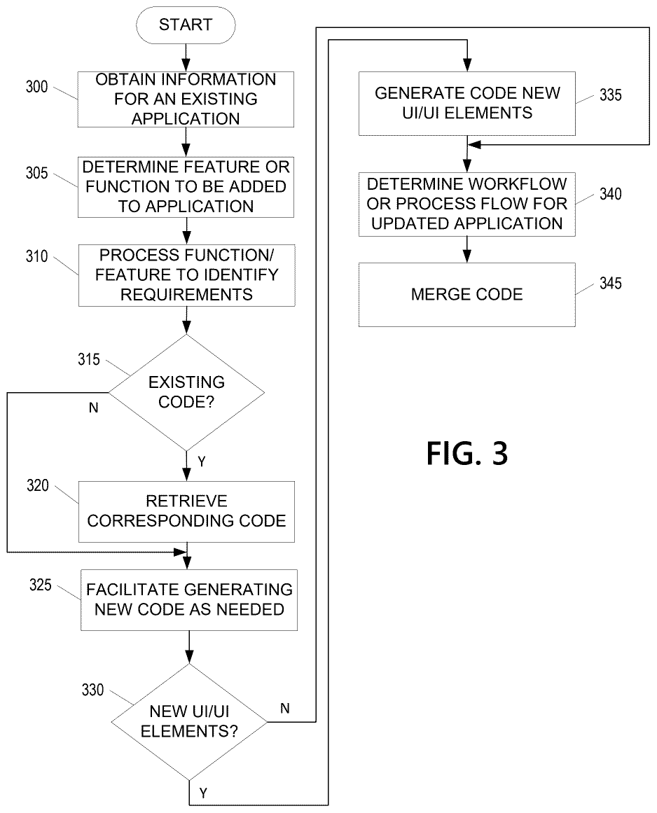

FIG. 3 is a flowchart illustrating a process by which an application may be customized or updated with one or more new features. In step 300, an application modification system may obtain information relating to an existing or original application. For example, the application modification system may be configured to host one or more desktop, mobile, or web applications (in addition to other applications) and allow access to those applications by one or more user devices. In some examples, the applications may be executed by a server associated with the application modification system. In other examples, the application may be downloaded and executed locally by a user device. In either case, the application modification system may monitor for user interactions associated with the application execution. Those user interactions may include user feedback, user interactions (e.g., clicks, text input, highlighting), an amount of time spent on a particular application interface, screen, field, etc., user requests, types of functions or features of the application activated or otherwise used by the user, and the like and/or combinations thereof. Additionally or alternatively, the system may collect or sort the user interactions according to application.

In step 305, the system may determine one or more features or functions to be added to a particular application based on the collected information from step 300. For example, a user may explicitly request a function or feature through the application. This request may be responsive to a prompt displayed in the application listing features or functions that do not already exist in the application but that may be added. In another example, a user may explicitly request a function or feature through a comment or other text input field. In other arrangements, the system may infer a request for a feature or function based on other user interactions including whether the user requested help for a particular portion or function of the application. Inferences may also be drawn based on an amount of time a user spends on a particular portion or function of the application. In one example, in a router configuration application, the system may determine that users often spend more than a threshold amount of time on entering an Internet Protocol (IP) address associated with their Internet service. Based on this information, the system may determine that a function or feature for electronically obtaining the user's IP address may be helpful in the application. Accordingly, inferences may be drawn based on a common user interaction or user interaction characteristic associated with the application. In another example, in a banking application, the system may determine that payee identity disputes often arise, and thus, infer that a payee identity confirmation function or feature may be desired or helpful in that application.

In step 310, once the system has identified a feature to be added to a particular application, the system may process the desired feature down to one or more functional requirements. That is, the system may identify the minimal functional elements or code required to implement the desired feature into the application. In one example, if a calculator function or feature is to be added to an application, the system may identify the smallest functional components that make up the calculator function. These components may be an addition function, a subtraction function, a multiplication function, and a division function. In one example, these smallest functional components may be defined for each function or feature in a database and identified based thereon. In other examples, the smallest functional components may be identified by correlating a description or portions of the description of the requested feature or function against a database of code segments and modules. In one or more arrangements, the function description may be provided by the user and parsed using a natural language processor. In a particular example, a requested feature may be described as a user authentication feature where a user is required to enter a username and password and to provide two-factor authentication. In consulting an application code database, the system may identify a first code module for validation of a username and password and a second code module for two-factor authentication. Accordingly, the validation of a username and password may be considered a first functional component while two-factor authentication may be identified as a second functional component.

In step 315, the system may determine whether the function or feature to be added corresponds to existing code segments and modules. In one example, the system may determine whether each of the functional components determined in step 310 corresponds to pre-existing code segments in an application code database. If pre-existing code is available for one or more functional components of the requested feature or function, the system may retrieve that code in step 320. For example, an application code database may store an association between a code segment or module identifier, a description of the code and a location for retrieving that code. The system may then access the location to obtain the relevant code segment or module.

In step 325, for any functional components that do not have pre-existing code defined, the system may facilitate the generation of the corresponding code for the functional element of the requested function or feature. For example, the system may provide a programming interface through which a user may define and generate code for a particular functional element. In some arrangements, generating code may further include retrieving basic code for various common services such as data transmission, data storage, data encryption, and the like. For example, the system may load a basic code library that a user may use to build the requisite code for the one or more functional elements.

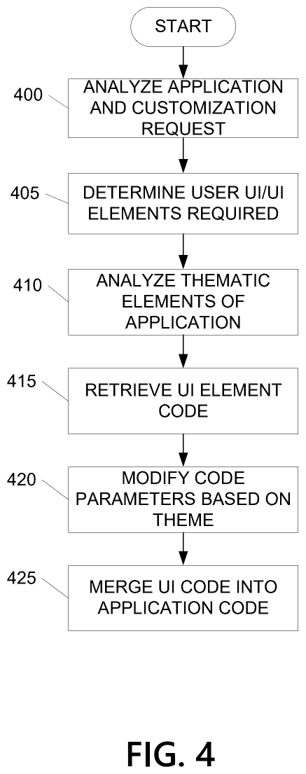

In step 330, the system may further determine whether a new user interface is required for implementing the new feature or function in the application. For example, if the to-be-added feature or function required its own interface screen, the system may generate a user interface using predefined user interface element code (e.g., buttons, input fields, radio buttons, images) in step 335. In one or more arrangements, the system may further customize the user interface based on determined user preferences and/or themes of the original application. Accordingly, prior to generating the user interface or during the user interface generation process, the system may determine user preferences (e.g., based on user interactions such as color selections, font selections, etc.) and/or an original theme of the application to be modified. Further details for generating a user interface is provided with respect to FIG. 4.

In step 340, the system may further determine a workflow or process flow for implementation of the new feature or function in the application. As discussed, the system may determine a timing or location within the application the feature or function is to be provided. For example, an application may have a particular flow from function to function and/or interface to interface. The system may determine an appropriate placement within the applications flow. For example, the system may determine that the feature or function is related to a particular interface element or function within the original application and identify a corresponding location for placing the new feature of function.

In step 345, the system may merge the code for the new feature or function with the code for the original application based on the determined workflow or process flow. For example, the system may insert the code segments into the original application code based on a location corresponding to the determined work or process flow. In another example, the system may insert code invocation commands in the original application code that are configured to invoke or otherwise trigger and incorporate the new feature or function into the execution of the original application at a particular time or point in the application execution. The location of the invocation may similarly be determined based on the work or process flow.

FIG. 4 is a flowchart illustrating a process for generating a customized user interface for a feature or function added to an original application according to one or more aspects described herein. For example, this user interface generation process may be used as part of step 330 of FIG. 3. Referring again to FIG. 4, in steps 400 and 405, an application customization and modification system may analyze an original application and a customization request to determine whether a user interface or user interface element is needed for the addition of a new feature or function, respectively. Analyzing the original application and the customization request may include determine the inputs and outputs required for the new feature, and parsing the original application code to determine whether those types of inputs or outputs are supported by the original application. In one example, the system may determine whether the new feature or function is a background function or whether the function requires output or input from the user. If the feature of unction is a background function that may use existing user interface elements, the system may determine that a new user interface or user interface element is not needed. If, on the other hand, the new feature or function requires a new type of input and/or a different output of information, the system may determine that a new user interface or user interface element is needed.

In step 410, upon determining that one or more new user interface elements are required, the system may determine and analyze thematic elements of the original application. These elements maybe visual, audible, textual, haptic and the like and/or combinations thereof. For example, a theme may be defined as a preferred or required set of colors. A theme may also be defined as a preferred set of one or more fonts, font sizes, border styles, table styles, input element styles (e.g., buttons styles, shadow level of a text input field, shape of a slider bar), set of one or more tones or audible elements, and/or types of haptic feedback (e.g., frequency and amplitude of haptic feedback). In some arrangements, a theme may be pre-defined or otherwise specified in association with the original application. For example, metadata or comments in the application code may be defined to specify user interface themes such as a preferred color, font, font size, organization of visual, textual, and audible elements within an application interface and the like and/or combinations thereof.

In step 415, the system may retrieve code corresponding to the needed user interface elements for the new feature or function to be added to the application. For example, the system may retrieve code for a button input element if the new feature or function calls for a button. The system may also retrieve code for a pop-up window if the new feature or function requires a pop-up window display element. A variety of different user interface elements may be required and code may be retrieved for each of those elements.

In step 420, once the user interface code is retrieved, the system may then modify code parameters based on the determined thematic elements. For example, the code may be modified to specify a particular color, font, font size, shape, haptic frequency, sound and the like and/or combinations thereof. The system may, in some arrangements, parse the user interface element code to identify visual, audible, textual, and/or haptic elements and modify the parameters of those code elements to match the identified theme.

In step 425, the system may then merge the user interface element code into the application code as part of the code integration of the new feature or function as discussed with respect to step 340 of FIG. 3.

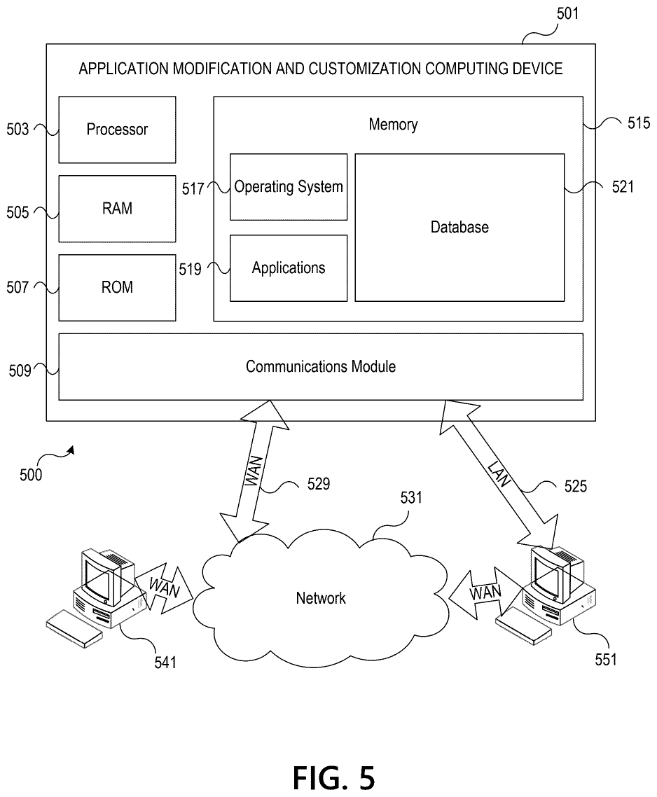

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include application modification and customization computing device 501 having processor 503 for controlling overall operation of application modification and customization computing device 501 and its associated components, including Random Access Memory (RAM) 505, Read-Only Memory (ROM) 507, communications module 509, and memory 515. Application modification and customization computing device 501 may include a variety of computer readable media. Computer readable media may be any available media that may be accessed by application modification and customization computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by application modification and customization computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on application modification and customization computing device 501. Such a processor may execute computer-executable instructions stored on a computer-readable medium.

Software may be stored within memory 515 and/or storage to provide instructions to processor 503 for enabling application modification and customization computing device 501 to perform various functions as discussed herein. For example, memory 515 may store software used by application modification and customization computing device 501, such as operating system 517, application programs 519, and associated database 521. Also, some or all of the computer executable instructions for application modification and customization computing device 501 may be embodied in hardware or firmware. Although not shown, RAM 505 may include one or more applications representing the application data stored in RAM 505 while application modification and customization computing device 501 is on and corresponding software applications (e.g., software tasks) are running on application modification and customization computing device 501.

Communications module 509 may include a microphone, keypad, touch screen, and/or stylus through which a user of application modification and customization computing device 501 may provide input, and may also include one or more of a speaker for providing audio output and a video display device for providing textual, audiovisual and/or graphical output. Computing system environment 500 may also include optical scanners (not shown).

Application modification and customization computing device 501 may operate in a networked environment supporting connections to one or more other computing devices, such as computing device 541 and 551. Computing devices 541 and 551 may be personal computing devices or servers that include any or all of the elements described above relative to application modification and customization computing device 501.

The network connections depicted in FIG. 5 may include Local Area Network (LAN) 525 and Wide Area Network (WAN) 529, as well as other networks. When used in a LAN networking environment, application modification and customization computing device 501 may be connected to LAN 525 through a network interface or adapter in communications module 509. When used in a WAN networking environment, application modification and customization computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A method comprising:
receiving, by an application server comprising at least one processor, information corresponding to user interactions with an application provided by the application server;
identifying, by the application server, a function to be added to the application based on the user interactions with the application, wherein identifying the function includes parsing the user interactions to extract one or more function descriptions of the function to be added;
comparing, by the application server, the one or more function descriptions to a database of code modules to determine if pre-existing code is available for the function;
in response to determining that pre-existing code is available for the function, retrieving, by the application server, the pre-existing code from a location specified in the database of code modules;
determining, by the application server, whether one or more user interface elements are to be added to the application for the function;
in response to determining that one or more user interface elements are to be added to the application for the function:
determining, by the application server, one or more themes associated with the application; and
modifying, by the application server, code associated with the one or more user interface elements to match the determined one or more themes; and
merging, by the application server, the pre-existing code with code of the application to generate a customized application having the function to be added.

2. The method of claim 1, wherein determining one or more themes associated with the application includes determining at least one appearance characteristic of the application.

3. The method of claim 1, wherein identifying a function to be added to the application based on the user interactions with the application comprises:
receiving a user request for the function to be added.

4. The method of claim 1, wherein identifying a function to be added to the application based on the user interactions with the application comprises:
capturing multiple user interactions with the application;
for each of the user interactions, determining at least one characteristic of the user interaction; and
determining a common characteristic of the user interactions.

5. The method of claim 1, further comprising:
determining a process flow for the application; and
determining a position within the process flow of the application where the function is to be placed.

6. The method of claim 5, wherein merging the pre-existing code with code of the application includes:
merging the pre-existing code at a position within the application corresponding to the determined position within the process flow of the application.

7. The method of claim 1, further comprising:
determining a plurality of functions to be added to the application; and
prioritizing the plurality of functions for addition to the application by:
determining whether each of the functions corresponds to pre-existing code; and
determining a priority for each of the functions such that functions corresponding to pre-existing code are assigned a higher priority than functions that do not correspond to pre-existing code.

8. An apparatus comprising:
a processor; and
memory storing computer-readable instructions that, when executed, cause the apparatus to:
receive information corresponding to user interactions with an application provided by an application server;
identify a function to be added to the application based on the user interactions with the application, wherein identifying the function includes parsing the user interactions to extract one or more function descriptions of the function to be added;
compare the one or more function descriptions to a database of code modules to determine if pre-existing code is available for the function;
in response to determining that pre-existing code is available for the function, retrieve the pre-existing code from a location specified in the database of code modules;
determine whether one or more user interface elements are to be added to the application for the function;
in response to determining that one or more user interface elements are to be added to the application for the function:
determine one or more themes associated with the application; and
modify code associated with the one or more user interface elements to match the determined one or more themes; and
merge the pre-existing code with code of the application to generate a customized application having the function to be added.

9. The apparatus of claim 8, wherein determining one or more themes associated with the application includes determining at least one appearance characteristic of the application.

10. The apparatus of claim 8, wherein identifying a function to be added to the application based on the user interactions with the application comprises:
receiving a user request for the function to be added.

11. The apparatus of claim 8, wherein identifying a function to be added to the application based on the user interactions with the application comprises:
capturing multiple user interactions with the application;
for each of the user interactions, determining at least one characteristic of the user interaction; and
determining a common characteristic of the user interactions.

12. The apparatus of claim 8, wherein the instructions, when executed, further cause the apparatus to:
determine a process flow for the application; and
determine a position within the process flow of the application where the function is to be provided.

13. The apparatus of claim 12, wherein merging the pre-existing code with code of the application includes:
merging the pre-existing code at a position within the application corresponding to the determined position within the process flow of the application.

14. The apparatus of claim 8, wherein the instructions, when executed, further cause the apparatus to:
determine a plurality of functions to be added to the application; and
prioritize the plurality of functions for addition to the application by:
determining whether each of the functions corresponds to pre-existing code; and
determining a priority for each of the functions such that functions corresponding to pre-existing code are assigned a higher priority than functions that do not correspond to pre-existing code.

15. A non-transitory computer-readable medium storing computer-readable instructions that, when executed, cause an apparatus to:
receive information corresponding to user interactions with an application provided by an application server;
identify a function to be added to the application based on the user interactions with the application, wherein identifying the function includes parsing the user interactions to extract one or more function descriptions of the function to be added;
compare the one or more function descriptions to a database of code modules to determine if pre-existing code is available for the function;
in response to determining that pre-existing code is available for the function, retrieve the pre-existing code from a location specified in the database of code modules;
determine whether one or more user interface elements are to be added to the application for the function;
in response to determining that one or more user interface elements are to be added to the application for the function:
determine one or more themes associated with the application; and
modify code associated with the one or more user interface elements to match the determined one or more themes; and
merge the pre-existing code with code of the application to generate a customized application having the function to be added.

16. The non-transitory computer-readable medium of claim 15, wherein determining one or more themes associated with the application includes determining at least one appearance characteristic of the application.

17. The non-transitory computer-readable medium of claim 15, wherein identifying a function to be added to the application based on the user interactions with the application comprises:
receiving a user request for the function to be added.

18. The non-transitory computer-readable medium of claim 15, wherein identifying a function to be added to the application based on the user interactions with the application comprises:
capturing multiple user interactions with the application;
for each of the user interactions, determining at least one characteristic of the user interaction; and
determining a common characteristic of the user interactions.

19. The non-transitory computer-readable medium of claim 15, wherein the instructions, when executed, further cause the apparatus to:
determine a process flow for the application; and
determine a position within the process flow of the application where the function is to be provided.

20. The non-transitory computer-readable medium of claim 19, wherein merging the pre-existing code with code of the application includes:
merging the pre-existing code at a position within the application corresponding to the determined position within the process flow of the application.
